(19) United States
(12) Patent Application Publication
(10) Pub. No.: US 2013/0117800 A1
(43) Pub. Date: May 9, 2013

(54) METHOD FOR PROVIDING A WIDGET SERVICE STREAMING THROUGH A BROADCAST NETWORK, AND APPARATUS FOR SAME

(71) Applicants: Sung-Oh Hwang, Yongin-si (KR); Kyung-Mo Park, Seoul (KR); Young-Sun Ryu, Seongnam-si (KR); Jae-Yeon Song, Seoul (KR)

(72) Inventors: Sung-Oh Hwang, Yongin-si (KR); Kyung-Mo Park, Seoul (KR); Young-Sun Ryu, Seongnam-si (KR); Jae-Yeon Song, Seoul (KR)

(73) Assignee: SAMSUNG ELECTRONICS CO., LTD., Suwon-si (KR)

(21) Appl. No.: 13/641,268

(22) PCT Filed: Apr. 14, 2011
(86) PCT No.: PCT/KR2011/002655

§ 371 Date: Dec. 26, 2012

Related U.S. Application Data
(60) Provisional application No. 61/324,019, filed on Apr. 14, 2010.

(51) Int. Cl. H04N 21/435

(52) U.S. Cl. CPC H04N 21/435
USPC 725/132

(57) ABSTRACT

Embodiments disclose a method of processing signals in a digital broadcast receiving apparatus. The method of processing signals in the digital broadcast receiving apparatus further includes: extracting information about at least one widget, associated with a current broadcast program, from streaming data received through a broadcast network; installing the at least one widget in the digital broadcast receiving device on the basis of the extracted information; and executing the installed widget using input data installed in the streaming data of the current broadcast program.

### FIELD

Embodiments relate to a method and apparatus for providing a widget service through a broadcast network based on a Moving Picture Experts Group (MPEG) transmission system.

### RELATED ART

In a related art, a method of using various content delivery services through a broadcast network by a user is largely classified into a non-real-time downloading method and a real-time streaming method.

According to the downloading method, digital media data desired by a user is previously downloaded from a server and stored in a client before a program start time, and a desired content service is used at a time desired by the user through the stored digital media data.

The streaming method includes a method of simultaneously delivering a plurality of content programs indicating services provided using various kinds of digital media data, e.g., broadcast, movie, and music data.

According to the streaming method, a user receives in real-time digital media data corresponding to a desired content program service and uses a desired content service through the digital media data. Thus, the streaming method is mainly used for content services corresponding to real-time broadcasts, such as relatively long media clips and sports broadcasting.

MPEG-2 Transport Stream (TS) is usually used as the streaming method is a transmission method for broadcast networks. In MPEG-2 TS, multiplexing of digital media data to be transmitted and robustness against a digital media data transmission error is provided. Thus, MPEG-2 TS is suitable for broadcast networks.

Related art digital TVs may provide a widget service. Widgets are applications, implemented in a small-sized icon form to display frequently used services on a screen, without using a web browser. When using widgets, a user may conveniently view news, the weather, a calendar, etc., through a digital TV.

However, in a related art streaming transmission method, a broadcast service and a widget service in a digital TV cannot be efficiently combined. Since a related art MPEG streaming transmission method is implemented by considering only acoustic and image data, a user must search for and install widgets using a network other than a broadcast network or an external interface. Therefore, a user may be inconvenienced when installing widgets in a digital TV. In addition, since most widgets relate to general information, not associated with contents of broadcast programs provided in a streaming service, it is difficult for a user to link widgets to broadcast programs for an optimized broadcast service.

### SUMMARY

Embodiments provide a method and an apparatus for providing a broadcast network, and widgets associated with a broadcast program provided in a streaming method.

According to an aspect of the embodiments, there is provided a method of processing signals in a digital broadcast receiving apparatus, the method including: extracting information about at least one widget, associated with a current broadcast program, from streaming data received through a broadcast network; installing the at least one widget in the digital broadcast receiving apparatus on a basis of the extracted information; and executing the at least one installed widget using input data included in the streaming data of the current broadcast program.

The extracting may include extracting the information about the at least one widget from program specific information (PSI) data or packetized elementary stream (PES) data of an MPEG-2 TS packet.

The extracting may include extracting the information about the at least one widget from a moov box or a mdat box of an MPEG-4 file.

The installing may include: displaying a list of widgets associated with the current broadcast program on the basis of the extracted information; and downloading a widget selected by a user, input through the broadcast network or an Internet Protocol (IP) network, on the basis of the extracted information.

The extracted information may include an identifier of a packet, the identifier of the packet includes installation data of the selected widget or an IP address of an external server supplying installation data of the selected widget from among the streaming data of the current broadcast program.

The method may further include deleting the at least one installed widget when the current broadcast program ends.

The executing may include extracting the input data from PSI data or PES data of an MPEG-2 TS packet.

The executing may include extracting the input data from a moov box or a mdat box of an MPEG-4 file.

The information about the at least one widget may be periodically inserted into the streaming data of the current broadcast program.

According to another aspect of the embodiments, there is provided a computer-readable recording medium storing a computer-readable program for executing the method.

According to another aspect of the embodiments, there is provided an apparatus for processing digital broadcast signals, the apparatus including: a widget information extractor which extracts information about at least one widget, associated with a current broadcast program, from streaming data received through a broadcast network; a widget installation device which installs the at least one widget in the apparatus on a basis of the extracted information; and a widget execution device which executes the at least one installed widget using input data included in the streaming data of the current broadcast program.

The widget information extractor may extract the information about the at least one widget from program specific information (PSI) data or packetized elementary stream (PES) data of an MPEG-2 TS packet.

The widget information extractor may extract the information about the at least one widget from a moov box or a mdat box of an MPEG-4 file.

The widget installation device may include: a widget list display device which displays a list of widgets associated with the current broadcast program on the basis of the extracted information; and a downloader which downloads a widget selected by a user, input through the broadcast network or an Internet Protocol (IP) network, on the basis of the extracted information.

The extracted information may include an identifier of a packet, the identifier of the packet includes installation data of the selected widget, or an IP address of an external server supplying installation data of the selected widget from among the streaming data of the current broadcast program.

The apparatus may further include a widget deletion device which deletes the at least one installed widget when the current broadcast program ends.

The widget information extractor may extract the input data from PSI data or PES data of an MPEG-2 TS packet.

The widget information extractor may extract the input data from a moov box or a mdat box of an MPEG-4 file.

The information about the at least one widget may be periodically inserted into the streaming data of the current broadcast program.

According to another aspect of the embodiments, a method of processing signals in a set-top box apparatus, the method including: extracting widget reference data, associated with a current broadcasting program, from broadcasting streaming data of a tuned channel, downloading widget basic data from an external server through an Internet Protocol (IP) network; and installing and executing at least one widget using widget input data from the broadcasting streaming data of the current broadcasting program of the tuned channel.

### DESCRIPTION OF THE DRAWINGS

The above and other features and advantages of the embodiments will become more apparent by describing in detail exemplary embodiments thereof with reference to the attached drawings in which:

FIG. 1 is a diagram for showing a concept of a widget streaming service according to an embodiment;

FIG. 2 is an image of a display screen of a widget according to an embodiment;

FIG. 3 is a block diagram for describing an MPEG streaming transmission method according to an embodiment;

FIG. 4 is a flowchart for describing a method of providing a widget streaming service according to an embodiment;

FIG. 5 is a flowchart for describing the method of FIG. 4 in more detail;

FIG. 6 is a signaling diagram for describing a method of providing a widget streaming service according to an embodiment; and

FIG. 7 is a block diagram of an apparatus for providing a widget streaming service according to an embodiment.

### DETAILED DESCRIPTION

Embodiments will now be described more fully with reference to the accompanying drawings, in which exemplary embodiments of the invention are shown.

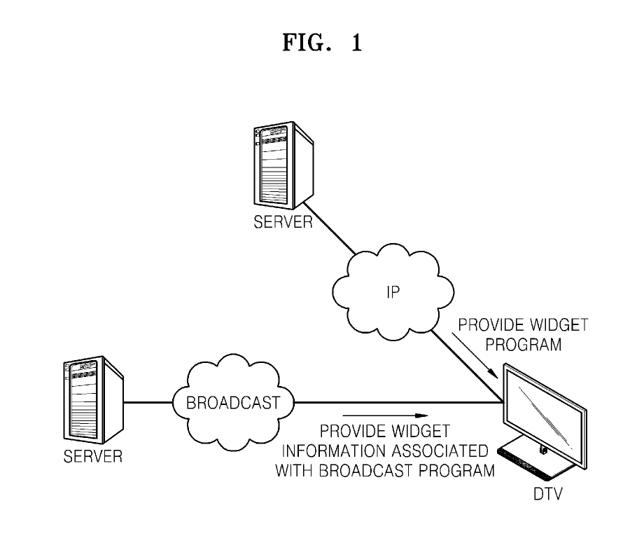

FIG. 1 is a diagram for showing a concept of a widget streaming service according to an embodiment.

As shown in FIG. 1, according to the embodiments, a digital TV (DTV) receives a broadcast service from a server connected to a broadcast network in a streaming method and also receives a widget service through the broadcast network. In detail, the DTV receives widget information associated with a corresponding broadcast program through streaming data of the corresponding broadcast program and installs a widget associated with a current broadcast program by receiving installation data of the widget (hereinafter, referred to as widget basic data) from a server connected to an Internet Protocol (IP) network on the basis of the received widget information. Input data required to execute the installed widget (hereinafter, referred to as widget input data) is also provided through the broadcast network. The DTV updates the widget input data being executed in the DTV every time such data is detected from streaming data of a broadcast program.

As described above, since DTVs or set-top boxes, supporting a service according to the embodiments (hereinafter, referred to as a widget streaming service) must independently access the broadcast network and the IP network, each of the DTVs or set-top boxes preferably include independent interfaces for two or more heterogeneous networks. However, embodiments are not limited thereto. In some exemplary embodiments, the widget basic data and the widget input data may also be received through the broadcast network.

As described above, according to the embodiments, a user may conveniently install a widget associated with a current broadcast program only by viewing the current broadcast program and may use an optimized broadcast service by combining a widget service and a broadcast service.

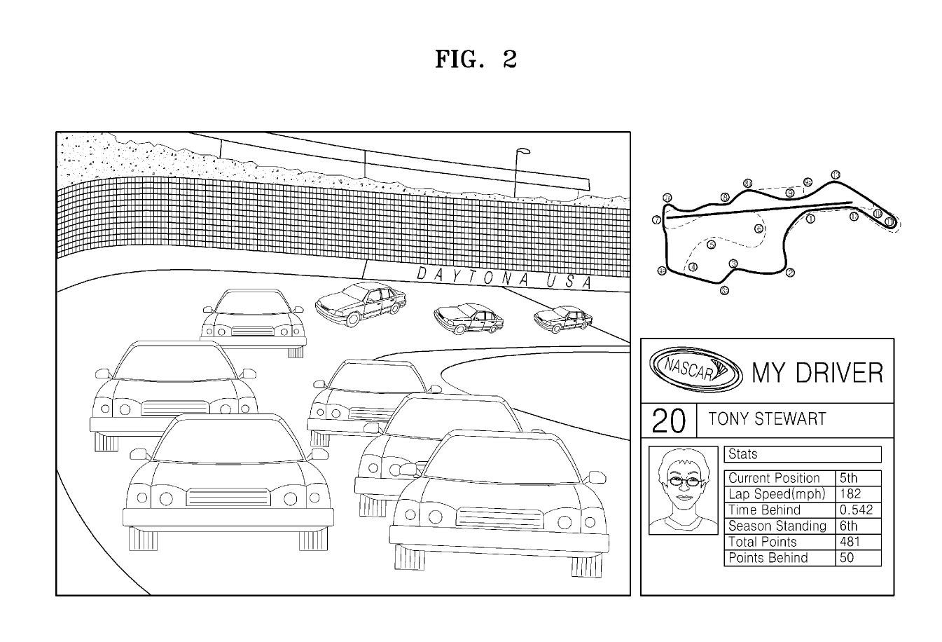

FIG. 2 is an image of a display screen of a widget according to an embodiment.

As shown in FIG. 2, when a broadcast program for broadcasting a motor race is provided in a streaming method, a widget for providing information about racers participating in the racing may be used to optimize this broadcast service. In other words, widget reference data is periodically included in streaming data of the broadcast program for broadcasting the motor race, and a DTV installs and executes the widget by receiving widget basic data through a broadcast network or an IP network on the basis of the widget reference data. Thereafter, every time widget input data included in streaming data is detected or every time widget input data is received in response to a user's request, the DTV updates input data of the widget being executed therein.

The widget input data may not be updated in response to a user's input or a command included in streaming data. In addition, the widget being executed may operate in a background without being displayed to the user, and the user may disable the widget being executed or delete the installed widget. In addition, the user may terminate the streaming widget service.

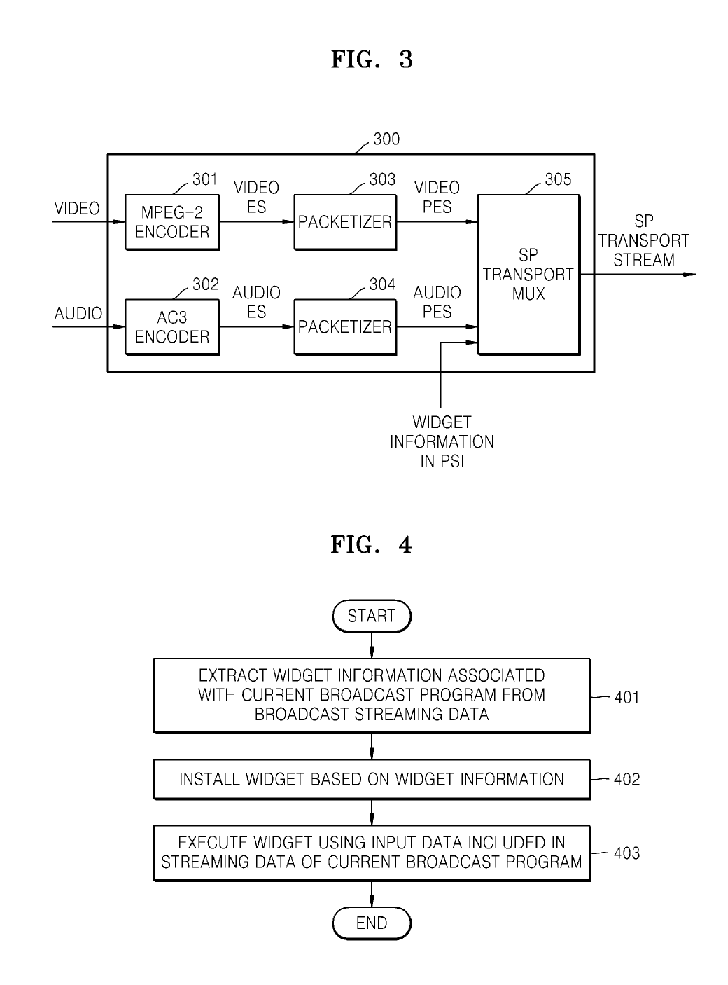

FIG. 3 is a block diagram for describing an MPEG streaming transmission method according to an embodiment.

When a broadcast environment in which an additional feedback channel configuration is impossible, a new digital media data configuration is required to provide a widget streaming service based on an existing streaming transmission method through a broadcast network. In the current embodiment, an encoder using an MPEG-2 method is illustrated.

As shown in FIG. 3, to provide a widget streaming service, an encoder 300 outputs a transport stream by encoding an image signal and an audio signal. In detail, the image signal is encoded to a video elementary stream (ES) by an MPEG-2 encoder 301, and the image ES is packetized to a video packetized elementary stream (PES) having a variable length by a packetizer 303.

The audio signal is encoded to an audio ES by an AC3 encoder 302, and the audio ES is packetized to an audio PES having a variable length by a packetizer 304.

The video PES and the audio PES are converted to transport stream (TS) packets, each TS packet having a length of 188 bytes, together with program specific information (PSI) by a multiplexer (MUX) 305, and is output as a single program (SP) transport stream including continuous TS packets.

The PSI is information required to extract and process corresponding broadcast program data from a TS by a DTV. The PSL information may include physical network information, a program identification number of a broadcast program, packet identifications (PIDs) of TS packets of audio/video, etc. As shown in FIG. 3, PSI data according to an embodiment, includes widget information. Thus, a widget streaming service may be provided to a user through a broadcast network.

To provide the widget streaming service, the DTV may be supplied with widget reference data, widget basic data, and widget input data.

The widget reference data includes information required to download the widget basic data. When the widget basic data is provided through the broadcast network, the information required to download the widget basic data may be a PID of a packet including the widget basic data. When the widget basic data is provided through an Internet Protocol (IP) network, the information required to download the widget basic data may be an IP address of a server. In addition, the widget reference data may further include a widget service identifier, indicating the presence of a widget service, a widget name, a widget producer and maker, a producing time, a version, security information, etc.

In addition, the widget reference data may further include information for accessing a widget store. In the widget store, various widgets can be browsed and downloaded. The user may download various widgets, associated with a specific broadcast program, a broadcast service provider, or a DTV manufacturer, from the widget store.

The widget basic data is binary data required to install the widget. The widget basic data includes digital media data, e.g., audio and video, to display the widget on a user screen.

The widget input data is used to update information about the widget already installed in the DTV, or update input parameters required to execute the widget.

According to an embodiment, the widget reference data and the widget input data may be included in the PSI data. The widget basic data may be included in a PES packet. However, a streaming data structure proposed in the embodiments is not limited thereto, and in some cases, all of the widget reference data, the widget basic data, and the widget input data may be included in the PSI data or the PES packet.

The widget streaming service may be based on a file format defined in an MPEG-4 standard. An MPEG-4 file is created based on a QuickTime file format and includes media data (mdat) and metadata (moov: movie metadata). The metadata may have access and play information of the mdat. When the widget streaming service is provided based on an MPEG-4 file, the widget reference data may be transmitted on a moov box of the MPEG-4 file, and the widget basic data may be transmitted on an mdat box of the MPEG-4 file. However, embodiments are not limited thereto. In some cases, all the widget data may be included in the moov box or the mdat box.

Since a time the user tunes into a channel is arbitrary, it is preferable that the widget data is periodically inserted into streaming data. The period of the inserted widget data may depend on characteristics and services of a broadcast network.

According to an embodiment, the DTV acquires widget basic data having a relatively long period, by analyzing widget reference data having a relatively short period. If the widget basic data is extracted from a broadcast stream, the DTV automatically installs a corresponding widget. Alternatively, the widget may be manually installed by the user requesting the widget basic data from a broadcast network server or an IP network server on the basis of a portion of the widget reference data, before the widget basic data is completely extracted.

FIG. 4 is a flowchart for describing a method of providing a widget streaming service according to an embodiment. The operations below may be a set-top box or a DTV supporting the widget streaming service.

Referring to FIG. 4, in operation 401, the DTV extracts widget information associated with a current broadcast program from broadcast streaming data. As described above, the widget information indicates widget reference data.

In operation 402, the DTV installs a widget in the set-top box or DTV on the basis of the extracted widget information.

In operation 403, the DTV executes the installed widget. Input parameters required to execute the widget, i.e., widget input data, are extracted from streaming data of the current broadcast program. Even while the widget is being executed, the widget input data is updated using the streaming data.

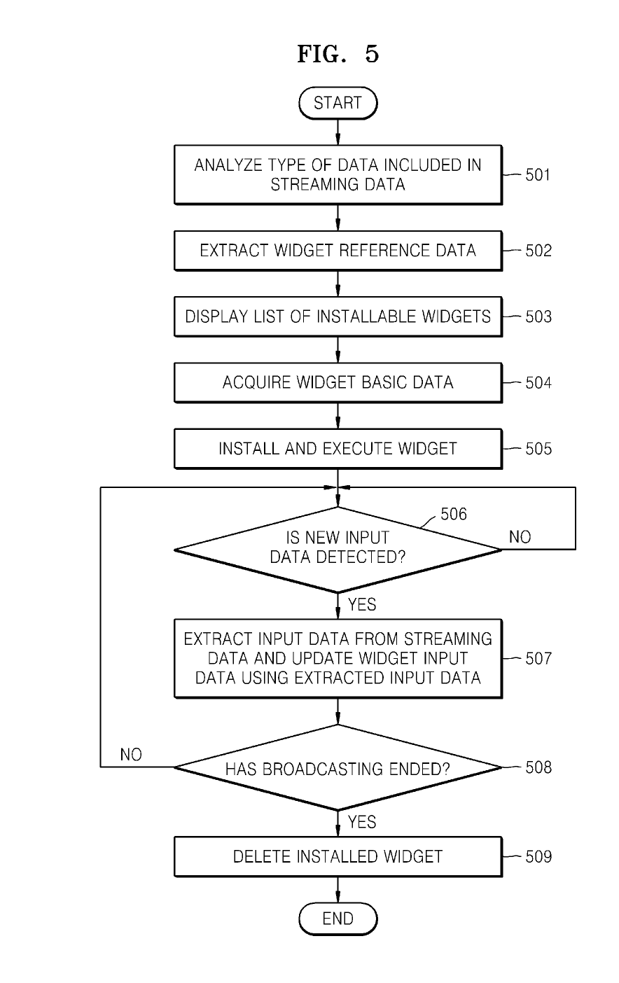

FIG. 5 is a flowchart for describing the method of FIG. 4. In FIG. 5, an MPEG-2 based streaming service is assumed. However, embodiments are not limited to MPEG-2 based streaming services.

Referring to FIG. 5, in operation 501, the DTV analyzes a type of data included in broadcast streaming data on the basis of PSI. In other words, it is determined which one of video information, audio information, and widget information is included in data included in a TS packet.

In operation 502, the DTV extracts widget reference data on the basis of the PSI. The widget reference data is extracted from PSI data or PES data of an MPEG-2 TS packet. When the widget streaming service is based on an MPEG-4 file, the widget reference data is extracted from a moov box or an mdat box of an MPEG-4 file.

As described above, the widget reference data includes information about a widget associated with a current broadcast program. The number of widgets associated with the current broadcast program may be plural.

In operation 503, the DTV displays a list of installable widgets, i.e., widgets associated with the current broadcast program. This list information is also included in the widget reference data.

In operation 504, the DTV acquires widget basic data required to install the widget on the basis of the widget reference data, in response to a user input. The widget basic data may be extracted from streaming data of the current broadcast program or downloaded from an external server through an IP network.

When the widget basic data is acquired through a broadcast network, the widget basic data is extracted from the PSI data or the PES data of the MPEG-2 TS packet. When the widget streaming service is based on an MPEG-4 file, the widget basic data is extracted from the moov box or the mdat box of the MPEG-4 file.

In operation 505, the DTV installs and executes the widget on the basis of the acquired widget basic data. In this case, widget input data to be used is also extracted from the streaming data of the current broadcast program. In detail, the widget input data is extracted from the PSI data or the PES data of the MPEG-2 TS packet, and when the widget streaming service is based on an MPEG-4 file, the widget input data is extracted from the moov box or the mdat box of the MPEG-4 file. Alternatively, the widget input data may also be received from the external server connected to the IP network.

In operation 506, the DTV determines whether new input data is detected from streaming data of the current broadcast program. If new input data is detected, the DTV extracts the new input data from the streaming data and updates the widget input data using the new input data in operation 507.

In operation 508, the DTV determines whether the current broadcast program has ended.

If the current broadcast program has ended, in operation 509, the DTV deletes the widget installed in operation 505. Alternatively, instead of deleting the widget, the DTV may disable the widget or end the widget streaming service if the current broadcast program has ended.

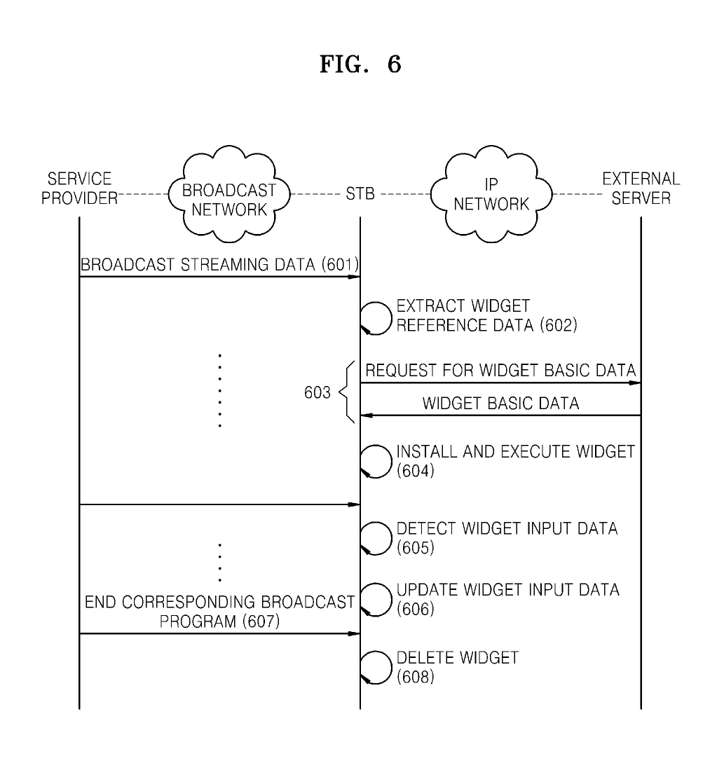

FIG. 6 is a signaling diagram for describing a method of providing a widget streaming service according to an embodiment. In this embodiment, it is assumed that an apparatus for providing the widget streaming service is a set-top box (STB) instead of a DTV. However, embodiments are not limited to a STB.

Referring to FIG. 6, in operation 601, a broadcast service provider transmits broadcast streaming data of a tuned channel to the STB.

In operation 602, the STB extracts widget reference data from the broadcast streaming data.

In operation 603, the STB downloads widget basic data from an external server through an IP network. In other words, in the current embodiment, instead of being extracted from the broadcast streaming data, the widget basic data is downloaded from a server in the IP network.

In operation 604, the STB installs and executes a widget in a DTV or the STB. Widget input data required to execute the widget is extracted from current broadcast streaming data.

In operation 605, the STB detects new widget input data from broadcast streaming data.

In operation 606, the STB extracts the new widget input data from the broadcast streaming data and updates input parameters of the widget being executed using the extracted widget input data.

If a current broadcast program has ended in operation 607, the STB deletes the widget installed in association with the current broadcast program in operation 608.

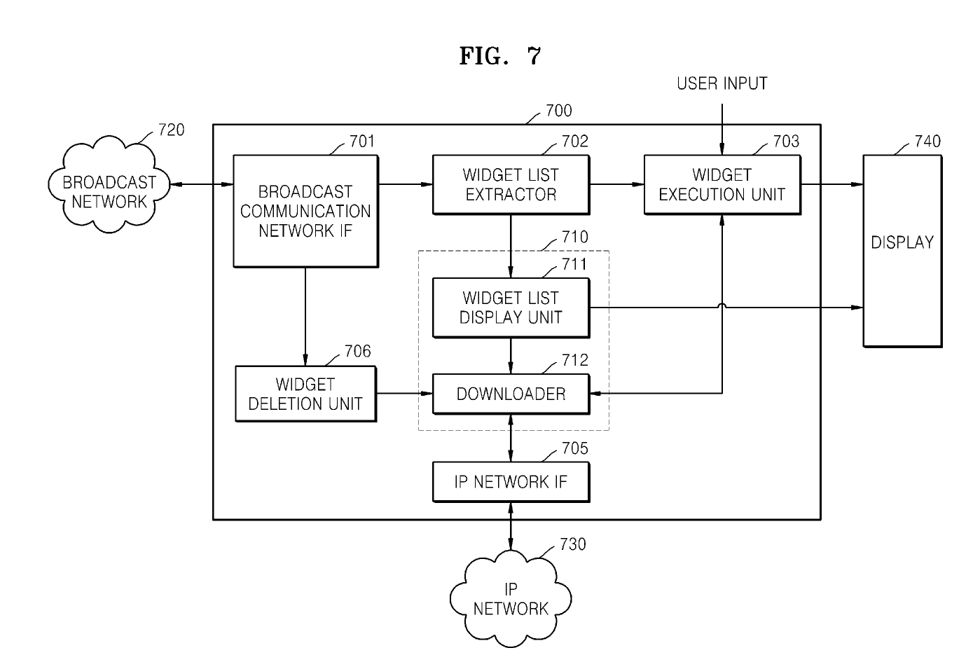

FIG. 7 is a block diagram of an apparatus 700 for providing a widget streaming service according to an embodiment.

As shown in FIG. 7, the apparatus 700 includes a broadcast communication network interface (IF) 701, a widget information extractor 702, a widget execution unit 703, a widget installation unit 710, an IP network IF 705, and a widget deletion unit 706.

The widget information extractor 702 extracts widget reference data of a widget associated with a current broadcast program from streaming data received by the broadcast communication network interface IF 701 through a broadcast network 720. The widget information extractor 702 extracts the widget reference data from PSI data or PES data of an MPEG-2 packet. If the widget streaming service is based on an MPEG-4 file, the widget information extractor 702 extracts the widget reference data from a moov box or an mdat box of the MPEG-4 file.

The widget information extractor 702 extracts widget input data from the PSI data or the PES data of the MPEG-2 packet. If the widget streaming service is based on an MPEG-4 file, the widget information extractor 702 extracts the widget input data from the moov box or the mdat box of the MPEG-4 file.

The widget reference data is periodically inserted into broadcast streaming data.

The widget installation unit 710 installs a widget associated with the current broadcast program on the basis of the widget reference data. As shown in FIG. 7, the widget installation unit 710 includes a widget list display unit 711 and a downloader 712.

The widget list display unit 711 displays, on a display 740, a list of widgets associated with the current broadcast program on the basis of the widget reference data.

The downloader 712 receives all or some of the widgets associated with the current broadcast program through the broadcast network 720 or an IP network 730 in response to a user input. In this case, the widget reference data is used to download a widget. In particular, downloading the widget includes downloading widget basic data. The widget reference data includes an identifier of a packet including widget basic data of a widget selected. The widget selected may be selected from an IP address of an external server, supplying the widget basic data of the widget selected from streaming data of the current broadcast program.

The widget input data may be provided through the IP network 730 instead of the broadcast network 720. In this case, the downloader 712 receives the widget input data from an external server (not shown) through the IP network IF 705.

The widget deletion unit 706 deletes the widget installed, in association with the current broadcast program, if the current broadcast program ends. Instead of deleting the widget, the widget may be disabled, or the widget streaming service may be terminated.

The embodiments can be written as computer programs and can be implemented in general-use digital computers that execute the programs using a computer-readable recording medium. Examples of the computer-readable recording medium include storage media such as magnetic storage media (e.g., ROM, floppy disks, hard disks, etc.), optical recording media (e.g., CD-ROMs, or DVDs), and carrier waves (e.g., transmission through the Internet). The embodiments may also be implemented by a processor, or a non-transitory computer readable medium.

While embodiments have been particularly shown and described with reference to exemplary embodiments thereof, it will be understood by those of ordinary skill in the art that various changes in form and details may be made therein without departing from the spirit and scope of the embodiments as defined by the following claims. The exemplary embodiments should be considered in a descriptive sense and not for purposes of limitation. Therefore, the scope of the embodiments is defined not by the detailed description, but by the appended claims, and all differences within the scope will be construed as being included in the embodiments.

1. A method of processing signals in a digital broadcast receiving apparatus, the method comprising:
extracting information about at least one widget associated with a current broadcast program, from streaming data received through a broadcast network;
installing the at least one widget in the digital broadcast receiving apparatus on a basis of the extracted information; and
executing the at least one installed widget using input data included in the streaming data of the current broadcast program.

2. The method of claim 1, wherein the extracting further comprises:
extracting the information about the at least one widget from program specific information (PSI) data or packetized elementary stream (PES) data of an MPEG-2 transport stream (TS) packet.

3. The method of claim 1, wherein the extracting further comprises:
extracting the information about the at least one widget from a moov box or a mdat box of an MPEG-4 file.

4. The method of claim 1, wherein the extracting further comprises:
displaying a list of widgets associated with the current broadcast program on the basis of the extracted information; and
downloading a widget selected by a user, input through the broadcast network or an Internet Protocol (IP) network, on the basis of the extracted information.

5. The method of claim 4, wherein the extracted information includes an identifier of a packet, the identifier of the packet includes installation data of the selected widget or an IP address of an external server supplying installation data of the selected widget from among the streaming data of the current broadcast program.

6. The method of claim 1, further comprising deleting the at least one installed widget when the current broadcast program ends.

7. The method of claim 1, wherein the extracting further comprises extracting the input data from PSI data or PES data of an MPEG-2 TS packet.

8. The method of claim 1, wherein the extracting further comprises extracting the input data from a moov box or a mdat box of an MPEG-4 file.

9. The method of claim 1, wherein the information about the at least one widget is periodically inserted into the streaming data of the current broadcast program.

10. An apparatus for processing digital broadcast signals, the apparatus comprising:
a widget information extractor which extracts information about at least one widget associated with a current broadcast program, from streaming data received through a broadcast network;
a widget installation device which installs the at least one widget in the apparatus on a basis of the extracted information; and
a widget execution device which executes the at least one installed widget using input data included in the streaming data of the current broadcast program.

11. The apparatus of claim 10, wherein the widget information extractor extracts the information about the at least one widget from program specific information (PSI) data or packetized elementary stream (PES) data of an MPEG-2 transport stream (TS) packet.

12. The apparatus of claim 10, wherein the widget information extractor extracts the information about the at least one widget from a moov box or a mdat box of an MPEG-4 file.

13. The apparatus of claim 10, wherein the widget installation device comprises:
a widget list display device which displays a list of widgets associated with the current broadcast program on the basis of the extracted information; and
a downloader which downloads a widget selected by a user, input through the broadcast network or an Internet Protocol (IP) network, on the basis of the extracted information.

14. The apparatus of claim 13, wherein the extracted information includes an identifier of a packet, the identifier of the packet includes installation data of the selected widget or an IP address of an external server supplying installation data of the selected widget from among the streaming data of the current broadcast program.

15. The apparatus of claim 10, further comprising a widget deletion device which deletes the at least one installed widget when the current broadcast program ends.

16. The apparatus of claim 10, wherein the widget information extractor extracts the input data from PSI data or PES data of an MPEG-2 TS packet.

17. The apparatus of claim 10, wherein the widget information extractor extracts the input data from a moov box or a mdat box of an MPEG-4 file.

18. The apparatus of claim 10, wherein the information about the at least one widget is periodically inserted into the streaming data of the current broadcast program.

19. A computer-readable recording medium storing a computer-readable program for executing the method of claim 1.

20. A method of processing signals in a set-top box apparatus, the method comprising:
extracting widget reference data, associated with a current broadcasting program, from broadcast streaming data of a tuned channel,
downloading widget basic data from an external server through an Internet Protocol (IP) network; and
installing and executing at least one widget using widget input data from the broadcasting streaming data of the current broadcasting program of the tuned channel.

21. The method of claim 20, further comprising:
detecting new widget input data from the broadcast streaming data;
extracting the new widget input data from the broadcast streaming data; and
updating input parameters of the at least one executed widget using the extracted new widget input data.

22. The method of claim 20, further comprising:
deleting the at least one widget installed when the current broadcast program ends.
